(19) United States
(12) Patent Application Publication
(10) Pub. No.: US 2009/0216935 A1
(43) Pub. Date: Aug. 27, 2009

(54) Memory device for a user profile

(76) Inventor: Bernd Flick, Diekholzen (DE)

Correspondence Address: KENYON & KENYON LLP, ONE BROADWAY, NEW YORK, NY, 10004, US

(21) Appl. No.: 11/918,852

(22) PCT Filed: Apr. 3, 2006
(86) PCT No.: PCT/EP2006/061286

§ 371 Date: Jan. 22, 2009

(30) Foreign Application Priority Data
Apr. 19, 2005 (DE) 102005018078.7

(51) Int. Cl. G06F 12/00

(52) U.S. Cl. 711/103; 711/E12.001

(57) ABSTRACT

A memory device for a user profile of a plurality of electronic devices or functional units in a motor vehicle is used for providing data corresponding to the user profile in the vehicle without a user having to make corresponding settings. As a result of being stored in the memory device, the user profile can be used in different vehicles.

### BACKGROUND INFORMATION

A recording unit for a memory stick in a vehicle is described in not yet published German Patent Application No. DE 102004005733. This recording unit is connected to a car radio, music data or individual data of a user such as a station preset for the car radio being stored in the memory stick. It is also possible to plan a route on an external computer and transfer it to the memory stick. A route traveled by the vehicle can be written to the memory stick.

### SUMMARY OF THE INVENTION

The memory device for a user profile according to the present invention has the advantage over the related art in that a user profile, for example, both personal activation data for the vehicle and personal contact data, are available to electronic devices or functional units in the vehicle. A driver may constantly carry such data with him and in particular use them in a plurality of vehicles as well. Due to the fact that it is also possible to remove sensitive data from the vehicle, the risk of a theft of such data is reduced. In addition, it is possible to simplify the exchange of data with other devices, in particular with other computing units and communication devices, via a preferably standardized interface. Advantageously, a user profile for a plurality of devices or functional units of the vehicle is stored in only one memory device. This eliminates the necessity of using a plurality of memory devices in order to set various functions according to a user profile of the driver. The user profile may be expanded to include new functions, or settings for functions no longer needed may be erased.

It is advantageous in particular to provide an interface on the memory unit for connecting to an external computing unit. This simplifies the exchange of data. In this connection, it is advantageous in particular to design this interface as a USB interface, as such interfaces are widely disseminated and make it simple to connect memory units.

In addition, it is advantageous to store audio data in the memory device for playback in the vehicle. This makes it possible to carry both the personal user data and also the audio data for use in the vehicle.

It is furthermore advantageous in particular to store the data in the memory device in such a way that it may be used independently of a vehicle or of a vehicle type. This makes it possible for a user to always obtain his desired setting of vehicle systems in different vehicles of possibly different types. For example, this simplifies the use of a rental car, as it is no longer necessary for the driver to learn the mode of operation of the vehicle, which may be different from his other vehicle, in order to carry out the desired settings of vehicle systems.

It is furthermore advantageous to store this setting in the memory device for the event that a setting of an electronic device is changed. The user profile is thus constantly updated in the memory device.

It is furthermore advantageous to store the user profile on the memory device in encoded form. This makes it possible in particular to protect sensitive personal data, in particular address data, against unauthorized use.

### BRIEF DESCRIPTION OF THE DRAWINGS

FIG. 1 shows a driver information device for connection of a memory unit according to the present invention.

FIG. 2 shows a schematic representation of a memory device according to the present invention.

### DETAILED DESCRIPTION

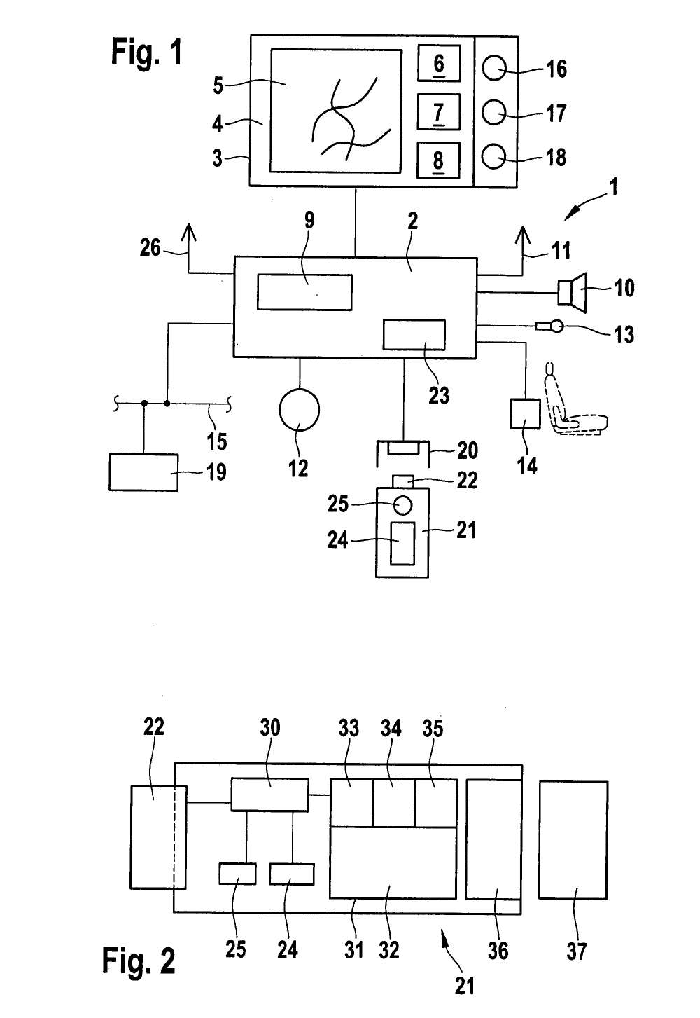

FIG. 1 shows a driver information device 1 which is situated in a motor vehicle. Driver information device 1 has a central processing unit 2 which is installed, for example in the instrument panel of the vehicle. Central processing unit 2 is connected to a display unit 3. Display unit 3 many also be mounted on the front of central processing unit 2. Display unit 3 has a display surface 4, on which a road map 5 is displayed in the exemplary embodiment shown here. Furthermore, three selection fields 6, 7, 8 are displayed in display surface 4. Control buttons 16, 17, 18 are assigned to selection fields 6, 7, 8 on display unit 3, the control buttons being situated next to display surface 4 in such a way that they are assigned to display surfaces 6, 7, 8, respectively. One of the commands shown in display fields 6, 7, 8 may be executed by operating one of control elements 16, 17, 18.

An image shown in display surface 4 is provided by a computing unit 9 which is situated in central processing unit 2. Central processing unit 2 is further connected to a speaker 10 which is used for audio output. Preferably, driver information device 1 has the function of a car radio. To this end, central processing unit 2 is connected to an antenna 11 which receives a radio program. Furthermore, a data medium inserted into a data medium drive 12 may be read out and music stored on it may be played back. In another preferred specific embodiment, driver information device 1 also has a telephone function. To this end, a microphone 13 is connected to central processing unit 2. A mobile telephone connection may be established by a mobile telephone antenna 26. On the one hand, a voice-bound connection may be established. An internet connection is also possible. This makes it possible to retrieve Web pages and display them on display surface 4. The telephone connection is designed, for example, as a GSM connection or a UMTS connection. In another specific embodiment, in particular mechanical and/or electronic settings in the vehicle may, for example, also be controlled by central processing unit 2. These settings may include, for example, a seat adjustment 14, a climate regulation, a ventilation control, a steering wheel setting and/or a mirror setting. It is also possible to access an engine control unit 19 via a data bus 15. By this means, it is possible, for example, to select trip parameters of the vehicle in accordance with the wishes of the user.

Driver information device 1 also has a connector 20 which is connected to central processing unit 2. A memory device 21 having a plug 22 matching connector 20 may be connected to connector 20. Memory device 21 may now be read out by computing unit 9 in central processing unit 2. Preferably, memory content may be transferred into a preferably volatile working memory 23 in central processing unit 2.

Voltage is supplied to memory device 21 preferably via the plug connection. If necessary, it may also have its own voltage source, so that in one specific embodiment it is also possible to use it after being withdrawn from connector 20. According to this specific embodiment, memory device 21 has a display 24 and at least one control element 25 for use outside of the vehicle. Memory device 21 may be designed in such a way that after it is removed from the vehicle, it is used as a portable music playback device to which, for example, headphones may be connected for music playback.

Plug connection 20, 22 for memory device 21 is preferably designed as a universal serial bus (USB) interface. This makes it also possible to connect memory device 21 to conventional personal computers, portable computers, or similar computing units. In this way, data may be written to memory device 21 using a computer, which is not shown in FIG. 1, and made generally available to driver information device 1 in the vehicle via connector 20 of computing unit 9.

The structure of memory device 21 is shown in detail in FIG. 2. Plug 22 is connected to a computing unit 30 which coordinates readout of a memory 31 and data transport via plug 22. In another specific embodiment, memory 31 may also be read out directly by computing unit 9 so that a separate computing unit 30 in memory device 21 may be dispensed with in this case. According to the specific embodiment sketched in FIG. 1, an optionally present display 24 and an optionally present control element 25 may also be controlled or read by computing unit 30 in memory device 21. Memory 31 of memory device 21 is preferably structured in such a manner that general data to be transported are stored in a first, generally accessible area 32. In this area, a user may, for example, store music data which may be played back from driver information device 1 via speaker 10 in the vehicle after having been read out. However, it may also be used to store any other kind of data which a driver would only like to transport, such as text or image data. In addition to the general area, memory 31 has at least one protected memory area 33. Memory area 33 is preferably assigned to one person. In a particular specific embodiment, data are stored in encoded form in memory area 33. For example, it is only possible to read the data out if a user enters a corresponding code via a suitable control unit in the vehicle, for example, via control buttons 16, 17, 18. Additional individually assigned memory areas 34, 35 may be provided in memory 31 for use by additional persons. Should memory 31 not be sufficient for storage of data, a connection point 36 is provided on memory device 21 in another specific embodiment, via which, for example, a memory card 37 may be inserted into memory device 21 to expand the existing memory.

In another specific embodiment, memory device 21 may also be designed only as a memory card. Independent of the type of design of the memory device, it may also, for example, be integrated in a code card for the vehicle. A user profile for a plurality of electronic devices in the vehicle or also for a plurality of functional units of an electronic device in the vehicle is stored in memory area 33. These functional units may be integrated in an electronic device, for example, in the form of driver information device 1 according to FIG. 1. In another specific embodiment, however, individual electronic devices may also be connected in the vehicle using connector 20. In addition, individual electronic devices may also be connected to driver information device 1, for example, via a data bus. The user profile may relate to all functions and devices but also to only a portion of the functions and devices.

By connecting memory device 21, for example in the form of plugging a memory unit designed as a USB stick into connector 20, the user profile stored in memory device 21 is transferred to driver information device 1. In another specific embodiment, the driver himself requests a transfer of the user profile, for example, via a control element of the vehicle's instrument panel or via a control element on the memory unit. In order to select a user profile, the driver may directly select one of the user profiles stored in memory areas 33, 34, 35 or he may identify himself so that a user profile assigned to him is transferred to driver information device 1 corresponding to the identity of the user. After the transfer, the devices and/or the functional units are set based on his wishes according to the stored user profile. If necessary, data assigned to the user profile are also provided.

The user profile may be configured in such a way that the user first connects memory device 21 to an external computing unit and conveniently carries out a configuration desired by him at that location. In another specific embodiment, it is also possible for the user to set a desired configuration of the electronic devices in the vehicle and store this configuration in memory device 21.

In particular in order to protect personal data, after plugging in memory device 21, a user identifies himself, for example by entering a code requested of him via display unit 3. Thereupon, the user profile including personal data is transferred to central processing unit 2. If necessary, the user may now also access personal contact data transferred into working memory 23. If memory device 21 is removed from the vehicle, these data in working memory 23 are erased when the vehicle is shut down at the latest.

A next user no longer has access to the configuration data. Mechanical and electronic settings such as, for example, seat adjustment 14 remain unchanged while, for example, a navigation device, a car radio function and/or a telephone function start in a default configuration after memory device 21 is removed and the vehicle is restarted, unless a new user profile is inserted.

The data are preferably stored in memory 31 in such a way that they may be read out by different vehicle models or different vehicle types. If, for example, a specific seat adjustment is desired, the seat is adjusted correspondingly in each compatible vehicle as long as the dimensions of the vehicle allow it.

In an exemplary embodiment which is not shown in FIG. 1, according to an enhancement, a wireless connection, for example a Bluetooth connection, may be provided between memory device 21 and driver information device 1 instead of plug connection 20, 22. In this case it would not be necessary to plug memory device 21 into a connector 20. It would merely be necessary to establish a Bluetooth connection to driver information device 1.

Examples of user profiles for different electronic devices in the vehicle are described in detail in the following. Memory device 21 should be designed in such a way that it offers the possibility of storing a profile in memory 31 for using the particular functions for at least two of these devices which are explained as examples or for other electronic devices or independent functional units.

Navigation Function

For a navigation function, it is possible to store destinations desired for a driver, in particular frequently selected destinations, in a list. Moreover, the most recently selected destinations may also be stored. In this case in particular, it may be of interest to a user that a following user not be able to trace each of his destinations. On the other hand, it is advantageous for a user to be able to enter destinations he may possibly desire in a simple manner without having to select them again if necessary in a complex manner. Therefore, a number of specified destinations are stored as a user profile in memory device 21. Furthermore, a user profile for navigation may also include a preferred road category or an average speed generally driven at by the driver. This makes it possible to simplify the operation of the navigation device and optimize both the route calculation to a destination as well as the time calculation for calculating the route.

Seat Adjustment

The position of the driver's seat may preferably be stored in memory device 21. After memory device 21 is connected, the desired seat position for the driver is adjusted. In a preferred specific embodiment, these data are stored in such a way that they may be read out independently of the vehicle. Therefore, a seat in a vehicle is always personally adjusted to the driver. To this end, memory device 21 must compare the stored size data of the driver with the spatial dimensions in the area of the driver's seat and the steering wheel in the particular vehicle and select a corresponding position of the seat for the driver.

Climate Control

The setting of the vehicle climate which is pleasant for a driver may also be stored in memory device 21. According to the corresponding wishes of the driver, the air conditioning system is regulated to produce the desired vehicle climate after memory device 21 is connected to driver information device 1.

Car Radio

A desired audio setting such as, for example, a tone setting, a speed-dependent loudness setting, a station preference or a program type setting, such as, for example, traffic radio or news is stored in memory device 21 and is available for a car radio function as part of the user profile.

Contact Data

Furthermore, personal contact data of the user are stored on memory device 21. They may be, for example, telephone numbers, internet addresses or e-mail addresses. Preferably, these data are transferred to the driver information device in such a way that a user is able to use driver information device 1 for establishing an internet connection, for writing an e-mail, or for establishing a telephone connection to the particular address holder. In this connection, most recently called numbers or preferred contacts may preferably be stored separately if necessary, so that a user is able to search for special telephone numbers very quickly. Without having to make an elaborate data transfer or a new entry, a user is able to use these data in different vehicles. Furthermore, he may synchronize them with other electronic devices so that he is, for example, also able to use the address data newly entered into his cell phone in the vehicle, if necessary. Furthermore, data present on a PC may be correspondingly transferred to memory device 21 in a simple manner and thus used in the vehicle. Conversely, e-mails or text messages also received in the vehicle having new address data may if necessary be written to memory device 21 and thus transferred to the user's computer or cell phone.

Music Playback

In particular for the case that music data are stored either on a data medium in data medium drive 12 or on memory device 21, a playlist may be stored as a user profile. It is thus possible, for example, to carry a large number of music titles on a mass storage medium in data medium drive 12. In this connection, it is possible, for example, to store several hundred music titles on a DVD data medium. In order to make it possible to adapt the playback to the individual musical taste of the user, it is preferably possible for the user to set up a playlist on his own computer, as a function of which a specific sequence and/or if necessary a specific subset of music titles on the data medium or on inserted memory card 37 or memory 31 are selected for playback. The stored playlist is a user profile that may be retrieved for playback with user assignment.

Engine Control

Depending on the vehicle, various levels of responsiveness of the power plant may be made possible. For example, a driver may select between an economical and in particular a sporty style of driving. The driving style desired by the driver may be stored in a corresponding user profile for the engine control in memory device 21.

User Rights

For the use of digital information or even specific functions in the vehicle based on computer programs, individual user rights may be granted. In particular for the playback of digitally stored pieces of music, it is possible that licenses may be necessary. Thus in some cases it could be problematic if pieces of music are transferred from memory device 21 into a memory of driver information device 1 in non-volatile form. This would create a new, digital copy of the stored piece of music. However, it is possible that a user has no rights to such a copy. The rights for playback or for temporary storage for processing may, however, be stored in a separate user profile in which such digital user rights are managed. Furthermore, it is also possible that a large number of pieces of music are carried in a mass storage medium and licenses for the use of these pieces of music may be acquired individually for a predetermined period. In this case, it would no longer be necessary to transfer the piece of music but instead only a time-limited user right. This may be obtained via a suitable internet connection and stored in memory device 21. To make a time check possible, driver information device 1 has, for example, a clock circuit or a time synchronization via the internet for this purpose.

Furthermore, it is, for example, also possible to allow or block specific vehicle functions via user rights. It is thus possible, for example, to equip a vehicle with a navigation function. However, the navigation function is only possible for a user if a corresponding user right, also possibly time-limited, is acquired and stored in memory device 21. This permission may relate not only to the use of one function itself but also to the use of data, for example in data medium drive 12. By acquiring a corresponding user right via the home computer and via the internet, a user could, for example, acquire the right to obtain a data record for a map base, for a vacation trip, for example, of France, which would be stored for one month in data medium drive 12. Since the user otherwise only drives on the German road network, he would have no need for such use the rest of the time. A time-limited utilization of the corresponding map base makes it possible to grant him this use, possibly, for a more economical price compared to permanent use. Moreover, it is also possible that a person who uses a plurality of vehicles at different locations will acquire the license for use only once; however, only he is entitled to these rights. If, for example, a map database for Western Europe as a whole is installed in a rental car, a user who has, for example, user rights for navigation in France, Germany, and Switzerland could also use these rights if he, for example, rents a corresponding vehicle in Germany. Another rental customer who does not have the corresponding rights is not able to use this function; however, he would also not have to pay for it.

Display

Furthermore, settings of display unit 3, such as, for example, a screen background, font, color settings for a user menu and/or the menu design itself, for example the form of selection fields 6, 7, 8 may also be stored in the user profile. When the user profile is activated, computing unit 9 sets the presentation in display surface 4 according to the wishes of the user.

1-10. (canceled)

11. A memory device for a user profile for a plurality of electronic devices and/or functional units of a motor vehicle, comprising:
an interface for creating a detachable connection of the memory device to the electronic devices and/or functional units and for transferring the user profile to the electronic devices and/or functional units.

12. The memory device according to claim 11, wherein the user profile includes contact data, including at least one of telephone contacts, internet addresses, and e-mail addresses.

13. The memory device according to claim 11, wherein the user profile includes user rights for data or programs stored in the electronic devices and/or functional units.

14. The memory device according to claim 11, wherein the user profile includes mechanical settings of at least one vehicle device and/or parameters for an operation of at least one device for a vehicle drive.

15. The memory device according to claim 11, wherein the user profile is stored in the memory device in such a way that it can be analyzed in a vehicle independently of a type of vehicle.

16. The memory device according to claim 11, wherein the user profile is stored in the memory device in changed form after a use of the electronic devices and/or functional units.

17. The memory device according to claim 11, wherein the user profile is stored in the memory device in encoded form.

18. The memory device according to claim 11, wherein the interface is adapted for connecting the memory device to an external computing unit.

19. The memory device according to claim 11, wherein the interface is a USB interface.

20. The memory device according to claim 11, wherein the memory device is used in a motor vehicle for controlling a plurality of electronic devices or functional units in the motor vehicle.
